(19) United States
(12) Patent Application Publication
(10) Pub. No.: US 2013/0042534 A1
(43) Pub. Date: Feb. 21, 2013

(54) MODULAR SLIDING DOOR SYSTEM

(71) Applicant: DORON POLUS, Agoura Hills, CA (US)

(72) Inventor: DORON POLUS, Agoura Hills, CA (US)

(21) Appl. No.: 13/211,218

(22) Filed: Aug. 16, 2011

(51) Int. Cl. E06B 3/46; E05D 15/06

(52) U.S. Cl. 49/425; 16/96 R

(57) ABSTRACT

A modular sliding door system includes a modular base with one or more lower tracks that may be removably connected in parallel, and ramps that may be connected to either side of a given lower track. The base may include one or more connectors that are configured to connect between two consecutive lower tracks. Each lower track has at least one longitudinal rail configured to receive a lower wheel assembly of a sliding door. The lower wheel assembly includes a lower wheel that has a transverse latch member disposed vertically below the lower wheel to slidably latch the lower wheel assembly to the lower track as the lower wheel rotates matingly on the longitudinal rail.

### FIELD OF INVENTION

This invention relates generally to sliding door systems and, more particularly, to a modular type of sliding door system that includes modular lower tracks that may be equipped with ramps on either side so as to allow the tracks to lie on top of a floor or other surface, or may be recessed into the flooring. This modular design allows one to easily add, relocate and uninstall the sliding doors. Further, with respect to lower tracks that lie on top of the floor, the ramps on either side of the lower tracks prevent one from tripping on the tracks as well as add stability to the sliding door.

### BACKGROUND OF THE INVENTION

Every sliding door usually has an upper track and a lower track. The majority of the weight of each door is carried by the lower track. As such, the upper track is generally designed in such a way as to guide the door so as to keep it in line and in place. As a result, the upper part of the door is usually looser, and typically creates undesirable noises caused by the friction between the upper part of the door and portions of the upper track.

In addition, it is important to ensure that sliding doors always remain in their tracks. Disengagement of a sliding door (or window, mirror, etc.) from its tracks is problematic for at least two reasons. First, the door, or portions thereof, might fall and break, thereby requiring costly repair or replacement. Second, and more importantly, a disengaged sliding door presents a significant health hazard not only to the individual operating the door, but also to any bystanders in the vicinity of the door.

Furthermore, in existing sliding door systems, each set of lower tracks has slots for two sliding doors. These lower tracks allow for two doors to slide in parallel alongside each other. If a user of a sliding door system wishes to place more than two sliding doors in parallel, however, the user must generally install multiple sets of lower tracks in parallel, with each set accommodating only two sliding doors. Such an installation is inconvenient and gives the sliding doors an aesthetically unpleasant and inconsistent look. Also, such an installation often results in a gap between the sets of lower tracks to accommodate for the width of the additional sliding doors. The resulting gap is not only unaesthetic, it can pose a hazard for people walking over the lower tracks. Multiple lower tracks installed in this manner would not meet the American with Disabilities Act (ADA) standards for safety.

Further, existing sliding door systems require the installation of the lower tracks into the flooring. Such installation prevents easy relocation, removal and addition of installed sliding doors.

Moreover, existing sliding doors provide little or no flexibility based on their functionality. More specifically, it may be desirable to customize a sliding door based on the door's intended function. Thus, for example, if the door is intended to function as a room divider, it may be desirable to have a “one-piece” panel design. On the other hand, if the sliding door is meant to be a sliding mirror or glass door for a closet, it may be desirable for the panel to be multi-faceted, e.g., have multiple horizontal or vertical panel designs.

With existing systems, the only way to achieve such function-based designs is to manufacture the door with multiple panels cut to produce the desired shapes and angles. Thus, in order for a glass door to appear as if it has three horizontal sections, for example, the door would have to be manufactured with three pieces of glass fitted within a frame that includes four horizontal frame members. This practice, however, requires that each and every sliding door be custom-made, thereby making it labor- and cost-intensive. In addition, once a door has been custom-made, the only way for a different design to be achieved—e.g., four horizontal sections instead of three—would be for another door to be custom made with the new specifications, thereby rendering the old door useless.

### BRIEF DESCRIPTION OF THE DRAWINGS

FIG. 1 shows a frontal view of a sliding door system in accordance with an embodiment of the invention;

FIG. 2 shows a sliding door, an upper track, and a lower track in accordance with an embodiment of the invention;

FIG. 3 shows a side view of two doors, an upper track, and a lower track in accordance with an embodiment of the invention;

FIG. 4 shows an upper roller assembly according to an embodiment of the invention;

FIG. 5 shows a lower wheel assembly according to an embodiment of the invention;

FIG. 6 shows an enlarged view of two sliding doors engaging a lower track in accordance with an embodiment of the invention;

FIG. 7 shows an exploded view of a lower wheel assembly according to an embodiment of the invention;

FIGS. 8A-8C show various design aspects of a sliding door system according to an embodiment of the invention;

FIG. 9A shows a single lower track in accordance with an embodiment of the invention;

FIG. 9B is a cross-sectional view taken along line I-I in FIG. 9A;

FIG. 10A shows a ramp member in accordance with an embodiment of the invention;

FIG. 10B is a cross-sectional view taken along line II-II in FIG. 10A;

FIG. 11A shows a connector in accordance with an embodiment of the invention;

FIG. 11B is a cross-sectional view taken along line III-III in FIG. 11A;

FIG. 12 shows one lower track and two ramp members in accordance with an embodiment of the invention;

FIG. 13 shows two lower tracks, two ramp members, and a connector in accordance with an embodiment of the invention;

FIG. 14 shows two lower tracks, two ramp members, and a connector joined together in accordance with an embodiment of the invention;

FIG. 15 shows three lower tracks, two ramp members, and two connectors joined together in accordance with an embodiment of the invention;

FIG. 16 shows four lower tracks, two ramp members, and three connectors joined together in accordance with an embodiment of the invention;

FIG. 17 shows a frontal view of a sliding door system in accordance with an embodiment of the invention;

FIG. 18 shows a sliding door, an upper track, and a lower track in accordance with an embodiment of the invention; and

FIG. 19 shows an exploded view of a lower wheel assembly according to an embodiment of the invention.

### DETAILED DESCRIPTION

It is noted that, although, throughout the ensuing discussion, reference is made to a sliding “door”, such reference is made by way of illustration, and not limitation. Thus, the instant invention encompasses sliding structures that may be used as doors (e.g., closet doors); room dividers; (wall) pocket doors, where the sliding “door” extends from, and retracts into, a wall cavity; wall sliders, where lower and upper tracks are placed next to a wall, such that the sliding “door” slides back and forth from behind the wall; etc. In addition, the term “door” is used herein generically and without limitation as to the material of which the door's panel is made. Thus, the panel may be made of clear glass, milky glass, frosted glass, mirror, etc., and combinations thereof.

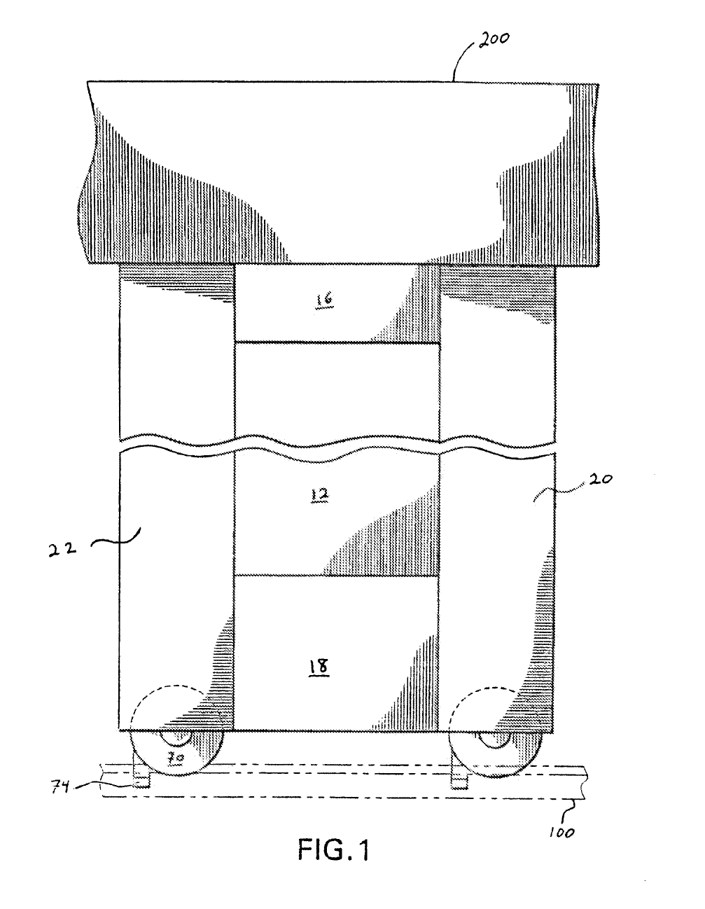

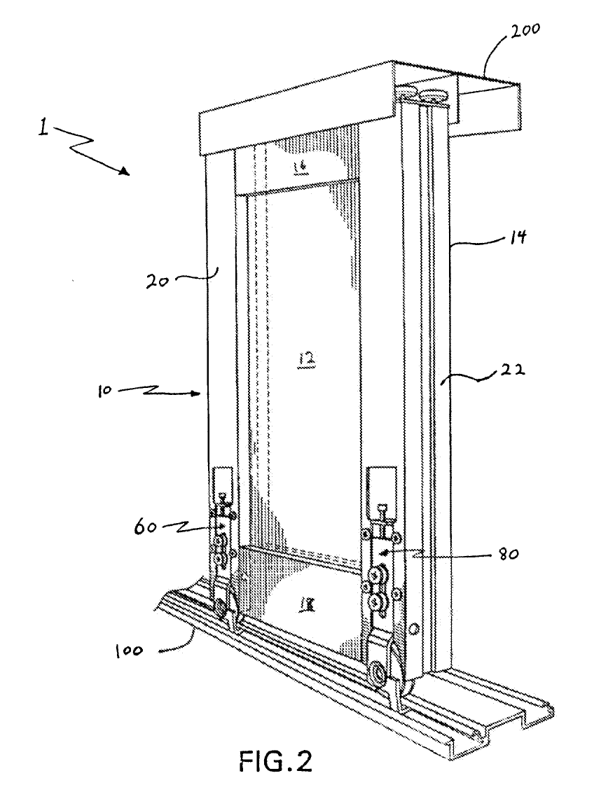

FIGS. 1 and 2 show a sliding door assembly 1, including a door 10, a lower track 100, and an upper track 200. The door 10 includes a panel 12 encased within a frame 14 which comprises a horizontal top portion (or member) 16, a horizontal bottom portion 18, a first vertical side portion 20, and a second vertical side portion 22. As shown, opposing horizontal members 16 and 18 are vertically spaced apart from one another, and opposing vertical members 20 and 22 are horizontally spaced apart from one another. In embodiments of the invention, the members 16, 18, 20, 22 may be made of aluminum. In addition, in embodiments where the panel 12 is made of glass, the glass may be tempered, and have a thickness of at least 4.0 mm, and more preferably, a thickness of at least 5.0 mm.

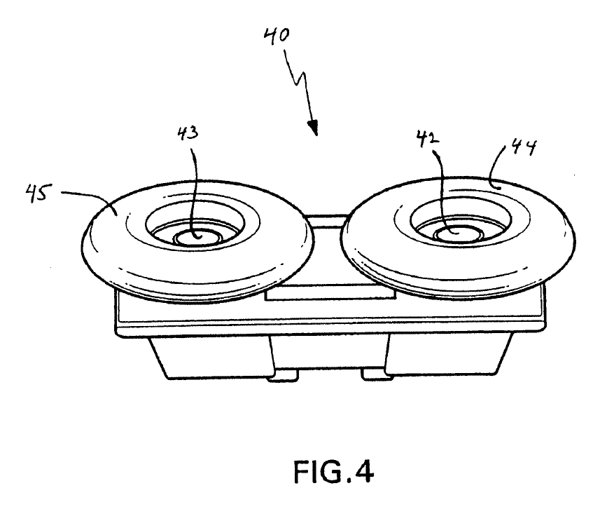

As shown in FIGS. 2-5, in a preferred embodiment, the door 10 includes at least one upper roller assembly 40 and one lower wheel assembly 60. The upper roller assembly 40 is coupled to an upper part of the frame 14 that is proximate the horizontal top portion 16, and the lower wheel assembly 60 is coupled to a lower part of the frame 14 that is proximate the horizontal bottom portion 18. Preferably, for each door 10, one upper roller assembly 40 is disposed atop each of the vertical side portions 20, 22, and one lower wheel assembly 60, 80 is disposed at the bottom of each of the vertical side portions 20, 22.

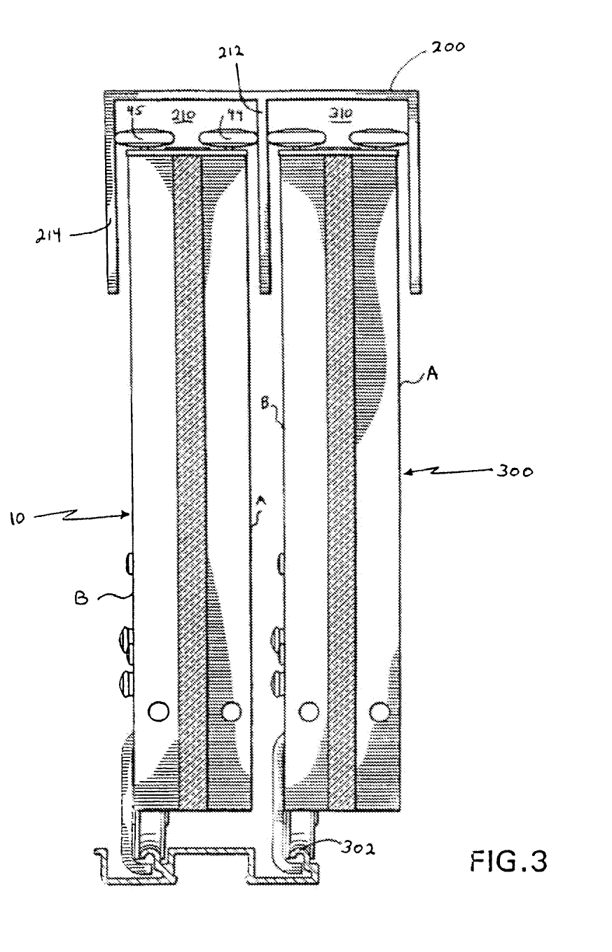

The upper roller assembly 40 includes first and second rollers 44, 45 that are rotatably mounted on respective first and second vertical shafts 42, 43. With reference to FIG. 3, the first shaft 42 is disposed adjacent the front side A of the frame 14, and the second shaft 44 is disposed adjacent the back side B of the frame 14. In this way, the periphery of the first roller 44 extends beyond the plane of the frame's (and door's) front side A, and the periphery of the second roller 45 extends beyond the plane of the frame's (and door's) back side B.

The above configuration is significant because it allows the door 10 to be stable and slide smoothly without any frictional contact between the upper track 200 and the door 10. Specifically, the upper track 200 defines at least one channel 210 having first and second opposing side walls 212, 214. As shown in FIG. 3, the first side wall 212 extends downwards over, and parallel to, the front side A of the frame's horizontal top portion, and the second side wall 214 extends downwards over, and parallel to, the back side B of the frame's horizontal top portion. As noted above, the combined span of the rollers 44, 45 extends beyond the width of the frame 14. As such, in operation, the first roller 44 rotates in frictional contact with an inner surface of the first side wall 212, and the second roller 45 rotates in frictional contact with an inner surface of the second side wall 214, thereby eliminating any frictional contact between the frame 14 and the side walls 212, 214.

It is noted that, in a preferred embodiment, the combined span of the rollers 44, 45 is slightly larger than the horizontal distance between the respective inner surfaces of the side walls 212, 214, and rollers 44, 45 are made of flexible rubber, so as to provide for a snug fit between the rollers 44, 45 and the side walls 212, 214. In addition, in embodiments of the invention, one or both of the side walls 212, 214 may extend far enough downwards to completely cover (the front side A, and/or the back side B, respectively, of) the horizontal top portion 16 of the frame 14.

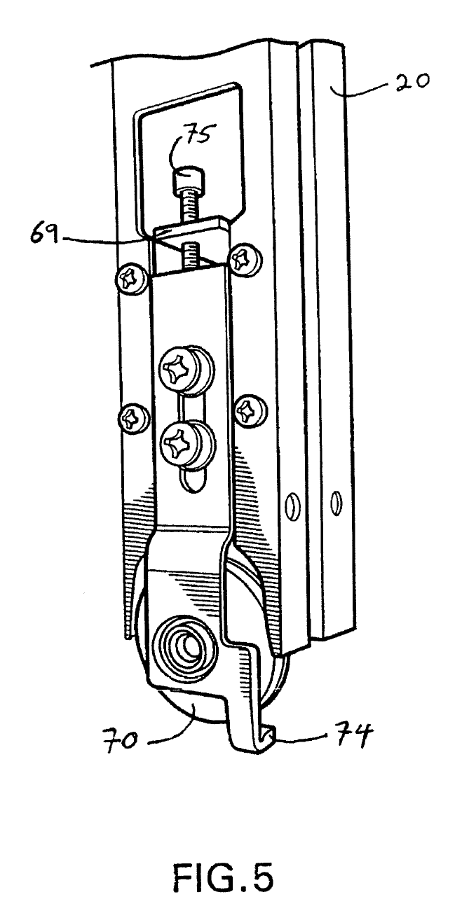

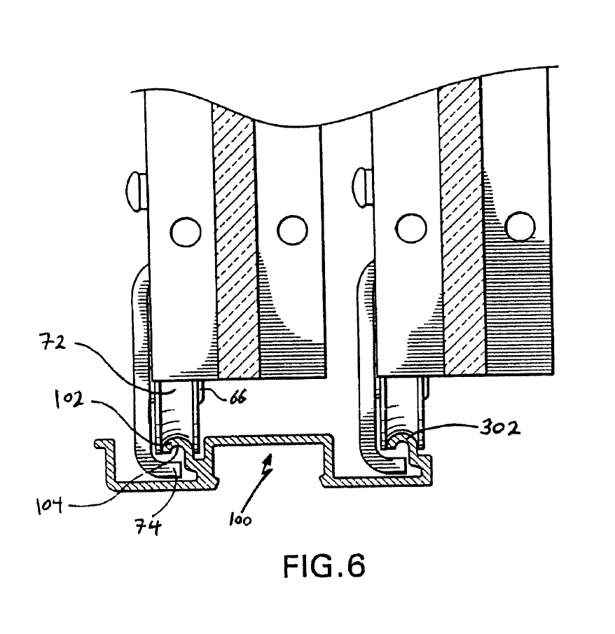

FIGS. 5-7 show details of the lower wheel assembly 60 and the lower track 100. In a preferred embodiment, the lower wheel assembly 60 includes a vertical spine 62 which, in turn, has a vertical slot 64 through its central portion. The vertical spine 62 also includes a transverse shaft 66 that is coupled towards a bottom portion of the spine, and a latch member 74 extending transversely from the vertical spine's bottom, at a location below the shaft 66. Rotatably coupled to the transverse shaft 66 is a lower wheel 70 that has a channel, or groove, 72 that runs along its periphery so as to define a concave contact surface for the lower wheel 70.

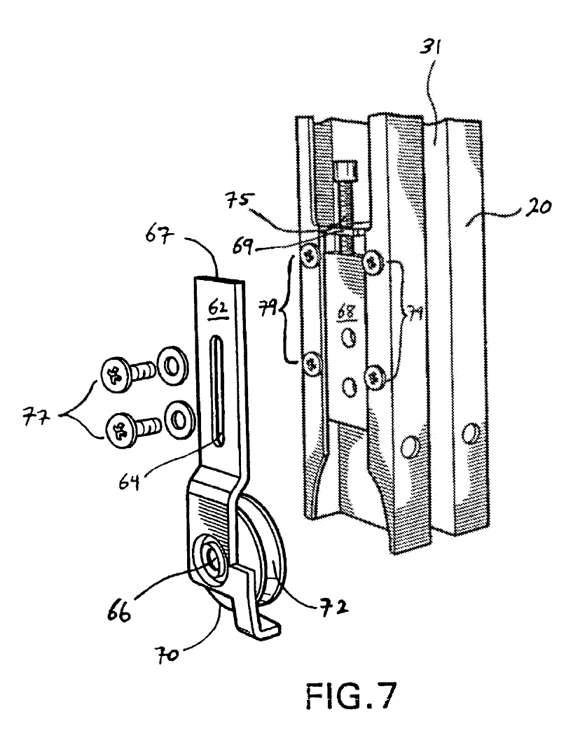

As shown in FIG. 7, the transverse shaft 66 is perpendicular to the plane of the panel 12, which is generally received within a straight groove, or channel, 31. It is noted that, although the groove 31 is shown in the figures only with respect to the vertical side portion 20 (see FIG. 7), the other parts of the frame 14, i.e., vertical side portion 22, horizontal top portion 16, and horizontal bottom portion 18 also have corresponding grooves, or channels, for receiving respective edges of the panel 12.

The spine 62 connects to a mounting bracket 68 by attachment means, such as, for example, screws or bolts 77, through the vertical slot 64. The mounting bracket 68, in turn, couples to the back side of the vertical side portion 20 using screws or similar attachment means 79. As shown in FIGS. 5 and 7, the mounting bracket 68 has an upper horizontal flap 69 that accommodates a vertically-oriented, adjustable safety screw 75.

In operation, the height of the vertical spine 62 (and, therefore, the height of the door 10) can be adjusted by moving the spine 62 up or down, and then fastening to the mounting bracket 68 at the desired location. Once the height has been set, the safety screw 75 is then adjusted such that its bottom rests on the top surface 67 of the spine 62, thereby preventing any vertical movement of the lower wheel 70 during use.

In one embodiment, the lower track 100 includes a convex longitudinal (rail) portion 102 that mates with the lower wheel's concave channel 72. In addition, a concave channel 104 defined by the underside of the convex longitudinal portion 102 provides a surface for engaging the latch member 74. Thus, the latch member 74 slidably engages the channel 104 such that, as the lower wheel 70 rotates on the outer side of the convex longitudinal portion 102, the door 10 remains latched to the lower track 100.

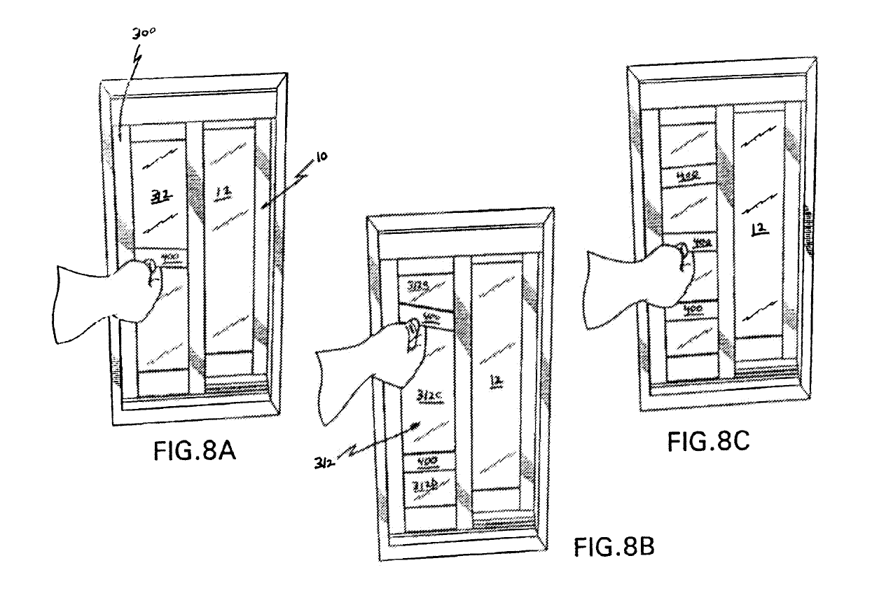

As noted previously, existing sliding doors allow little to no flexibility in panel design. As shown in FIGS. 8A-8C, however, an aspect of the instant invention is to provide divider strips 400 that may be removably attached, e.g., via double-sided tape, to the panel 12, 312. Thus, for example, in FIG. 8A, a single divider strip 400 is attached to the panel 312 so as to provide the appearance of two separate (i.e., upper and lower) panels. Similarly, in FIG. 8B, two dividers are used, and in FIG. 8C, three dividers are used to provide an appearance, respectively, of three and four separate panels.

It is noted that, because the dividers 400 can be placed anywhere on the panel, the resulting appearance can be asymmetrical, if such asymmetry is desired. Thus, for example, in FIG. 8B, the top and bottom portions 312a, 312b are smaller than the middle portion 312c. In addition, the dividers may be placed on the panel 12, 312 horizontally, vertically, diagonally, and/or in a combination of orientations. For example, a panel may include a “T” configuration on the bottom, and an inverted “T” configuration on top, etc.

Various modifications may be made to embodiments of the invention. For example, although the figures depict, illustratively, an upper track 200 with two channels 210, 310, the upper track 200 may include as few (e.g., a single one), or as many, channels as may be needed to implement the invention. Similarly, although the lower track 100 is shown, illustratively, to accommodate either one or two doors 10, 300, the lower track 100 may be made so as to accommodate one or more doors, depending on the intended use and the area to be covered by the door(s).

For example, when a single door is to be used, the upper track 200 may include a single channel 210, and the lower track 100 may include a single convex longitudinal portion 102 to support the lower wheel assembly 60. On the other hand, when two doors are to be used, the upper track 200 may include two channels 210, 310, and the lower track 100 may include two longitudinal portions 102, 302.

In addition, the same configuration may be used when more than two doors are necessary. Thus, for example, when four doors are to be used, each of the channels 210, 310, and each of the longitudinal rails 102, 302 may accommodate two doors, and the doors may slide between the upper and lower tracks in alternative positions. That is, the first and third doors may be accommodated by the first channel and longitudinal portion, and the second and fourth doors may be accommodated by the second channel and longitudinal portion. Alternatively, the first and fourth doors may be accommodated by the first channel and longitudinal portion, and the second and third doors may be accommodated by the second channel and longitudinal portion. Other similar configurations may also be used, as necessary.

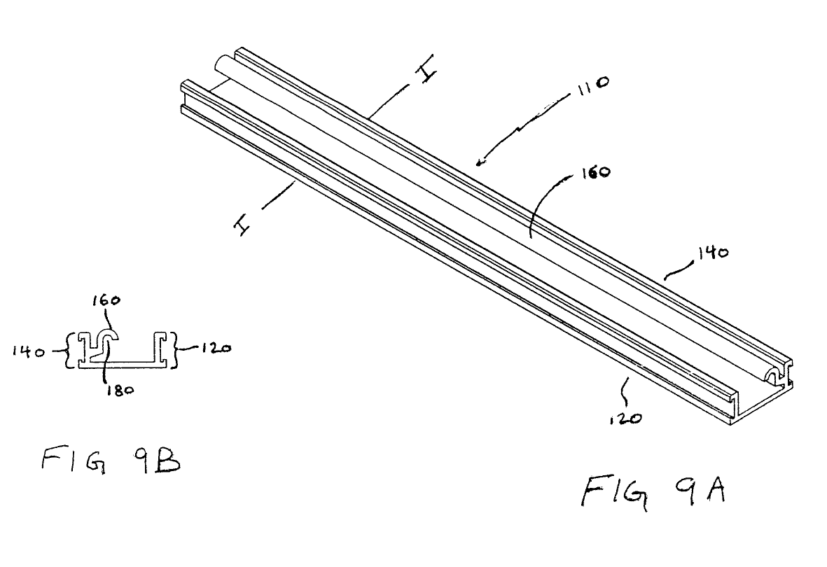

In accordance with a further embodiment of the invention, FIGS. 9A and 9B show a lower track 110 having a first longitudinal side 120 and a second longitudinal side 140. The lower track 110 may include a longitudinal portion 160. The longitudinal portion 160 may be convex in shape, forming a concave channel 180 on the underside of the longitudinal portion 160.

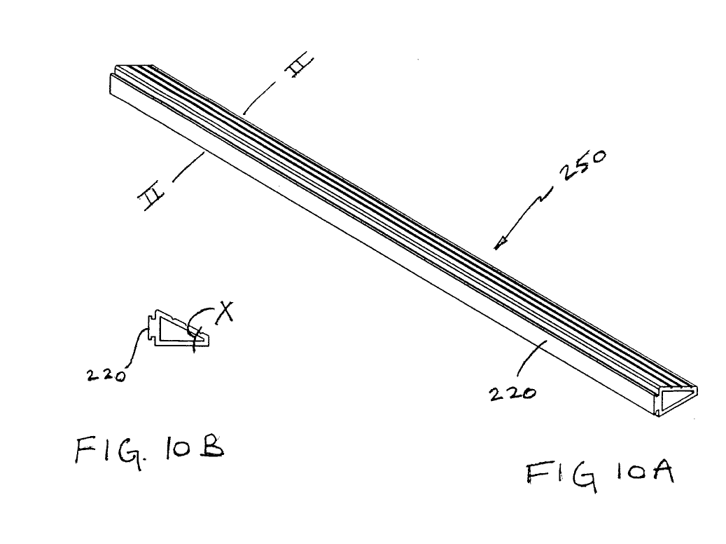

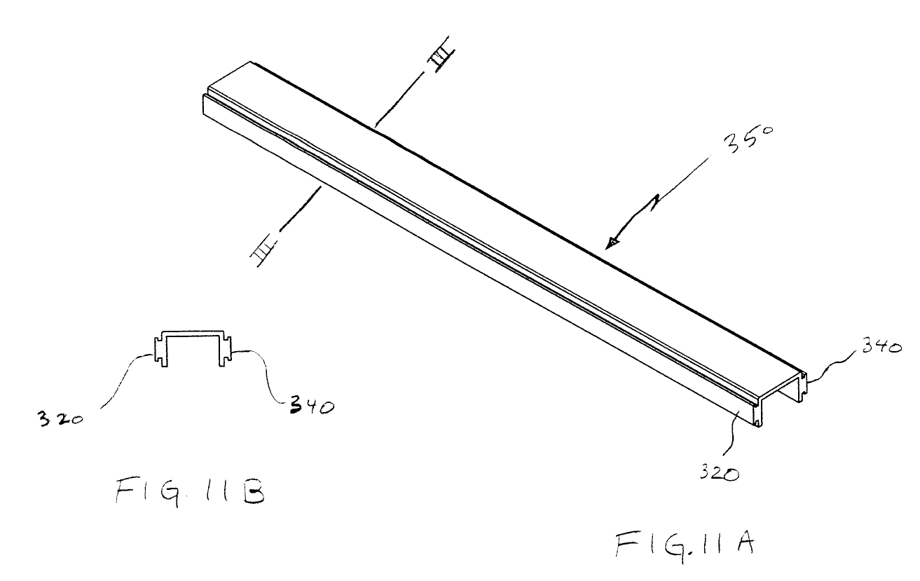

FIGS. 10A and 10B show a ramp member 250 having a longitudinal side 220 and a slope of angle X. In a preferred embodiment of the invention, angle X may be about 26°. FIGS. 11A and 11B show a connector 350 having a first longitudinal side 320 and a second longitudinal side 340. As can be seen from FIGS. 9-11, the sides 120, 140 of each lower track 110 have a generally C-shaped cross-section so as to form longitudinal channels. Each of the sides 320, 340 of each connector 350, and the side 220 of each ramp 250, in turn, is shaped so as to be matingly and slidably received within one such longitudinal channel.

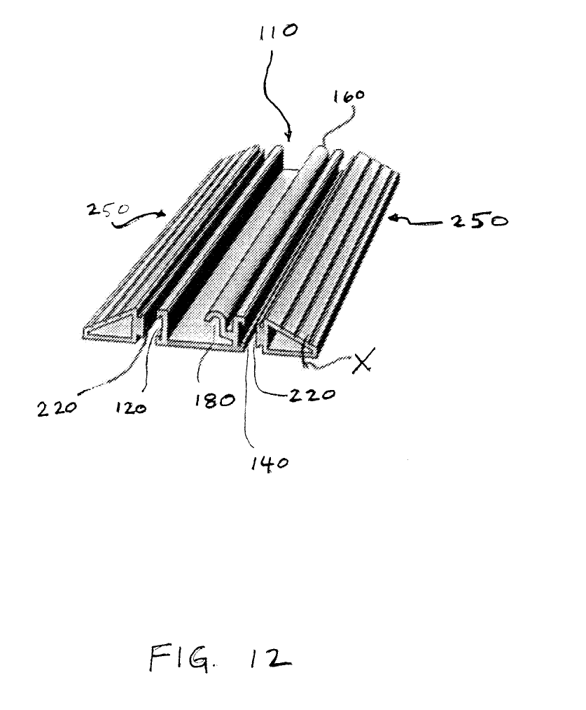

As shown in FIG. 12, ramps 250 are configured to be coupled to the lower track 110, and allow the lower track to be placed on top of a floor or other surface. By effectively widening the base of the lower track 110, the ramps provide stability to a sliding door engaged to the lower track 110. The ramps also reduce the likelihood of a person tripping on a lower track 110, which would otherwise be protruding from the floor. As stated above, in a preferred embodiment, the angle (X) of the ramp with respect to the horizontal may be 26°. A ramp at this angle provides sufficient stability to the sliding door and a gradual slope to reduce the likelihood of one tripping over the lower track, both without requiring a base that is so wide as to be aesthetically unpleasant or inconvenient. The above configuration of lower tracks and ramps are compliant with American with Disabilities Act (ADA) standards for safety.

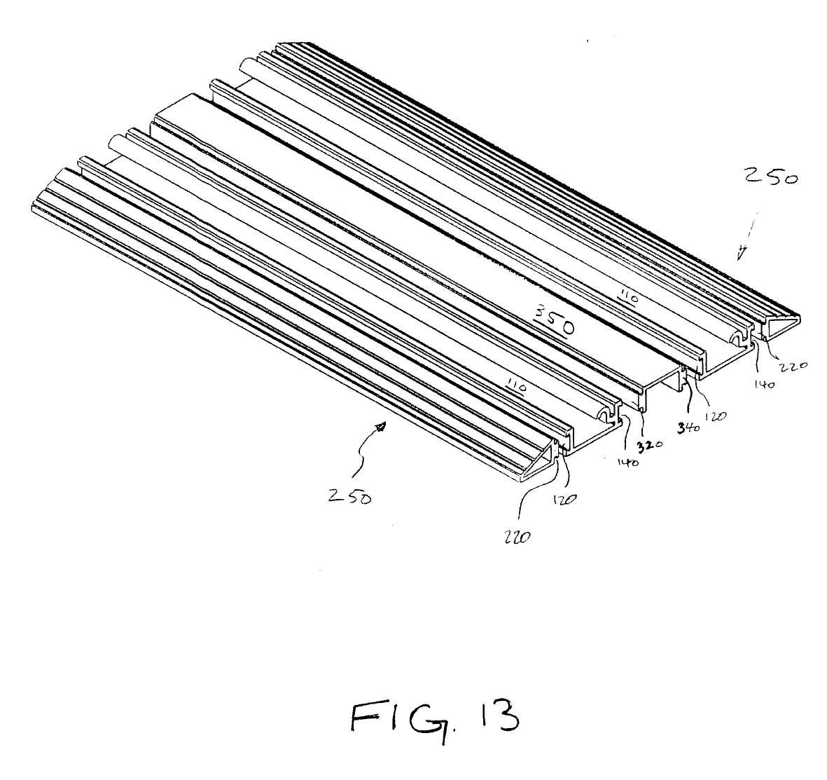

FIG. 13 shows two lower tracks 110, each of which is configured to connect to a connector 350. Thus, the first lower track 110 may be removably connected to the connector 350 by sliding one end of the second longitudinal side 140 of the first lower track 110 through the channel formed on the first longitudinal side 320 of the connector 350 until the ends of the first lower track 110 and connector 350 are flush. Similarly, the second lower track 110 may be removably connected to the connector 350 by sliding one end of the first longitudinal side 120 of the second lower track 110 through the channel formed on the second longitudinal side 340 of the connector 350 until the ends of the second lower track 110 and connector 350 are flush.

FIG. 13 further shows ramps 250, each of which is configured to connect to a respective one of the two lower tracks 110. Thus, the first lower track 110 may be removably connected to a first ramp 250 by sliding one end of a first longitudinal side 120 of the first lower track 110 through the channel formed on the longitudinal side 220 of the first ramp 250 until the ends of the first lower track 110 and the first ramp 250 are flush. Likewise, the second lower track 110 may be removably connected to a second ramp 250 by sliding one end of a second longitudinal side 140 of the second lower track 110 through the channel formed on the longitudinal side 220 of the second ramp 250 until the ends of the second lower track 110 and the second ramp 250 are flush.

In a preferred embodiment, the sliding door assembly includes a unique base, known as “Smart Track,” having one or more connectors 350 that are configured so as to enable two or more doors to slide next to and past each other without touching.

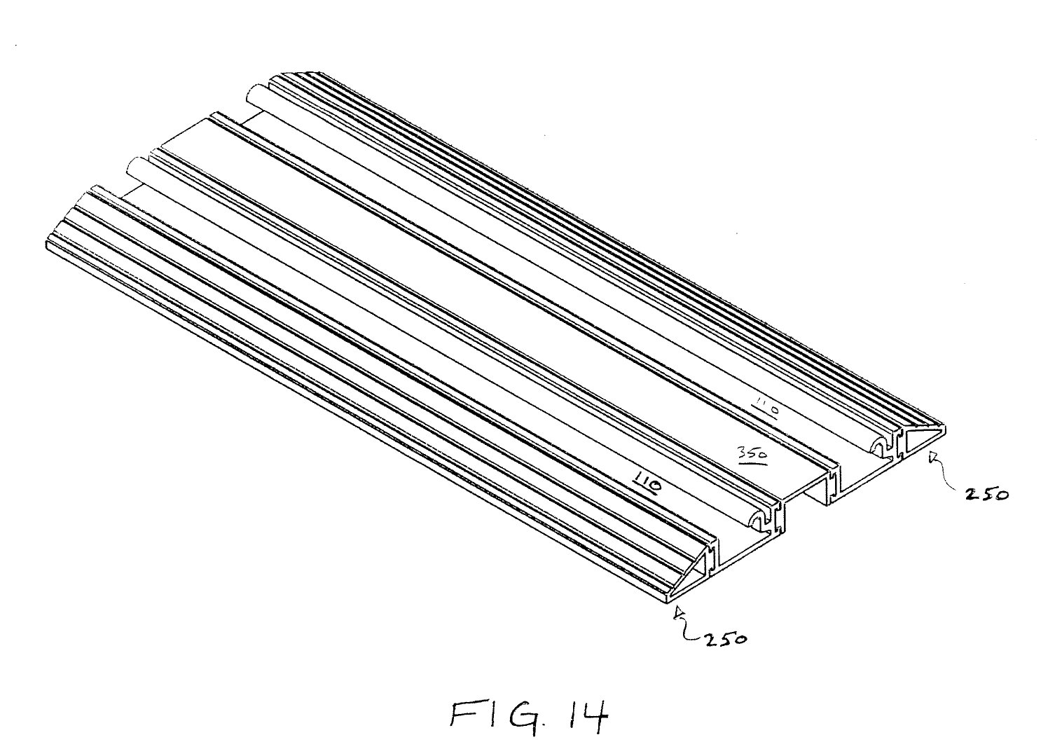

As shown in FIG. 14, in one preferred embodiment, a base for a sliding door system having two doors includes two lower tracks 110 joined together by a connector 350, where each lower track 110 is also connected to a respective ramp 250 on a side opposite the side that is connected to the connector. Thus, this embodiment allows for two sliding doors to slide adjacent to, and in parallel with, each other. It further allows for the base of the sliding door to be placed above the floor, in accordance with the invention.

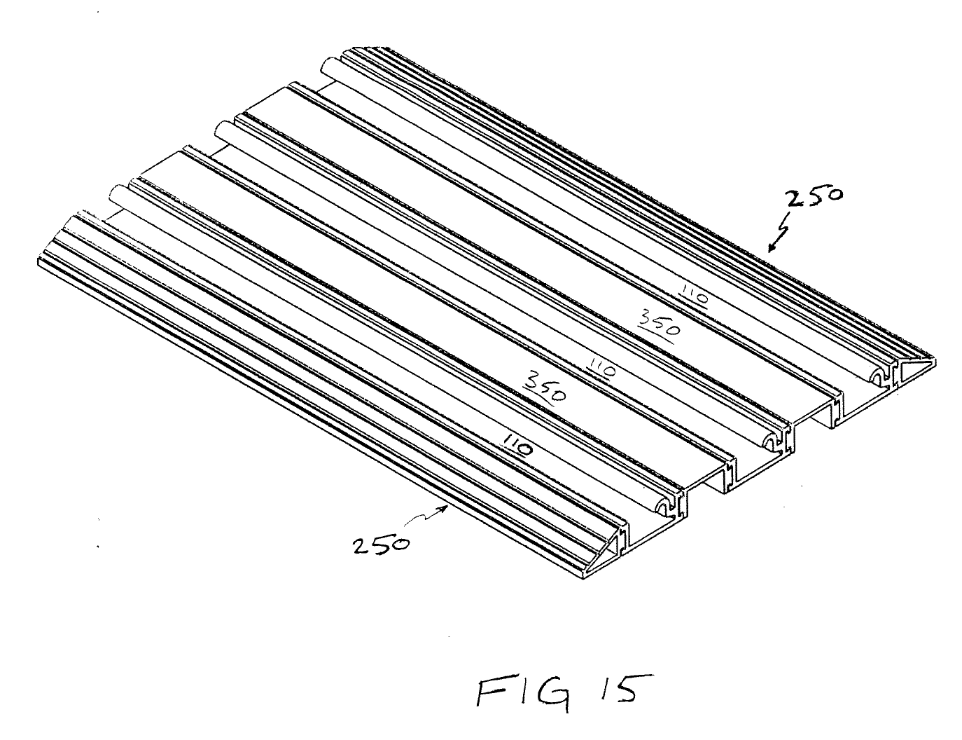

In another preferred embodiment, shown in FIG. 15, a base for a sliding door system that has three doors includes three lower tracks 110, with each of two “outer” lower tracks 110 connected to a respective ramp 250 on one side and a respective connector 350 on the opposing side. The remaining “inner” lower track 110 is then connected to, and between, the two connectors 350. This innovative “Smart Track” base provides the sliding door assembly with a consistent and aesthetically pleasant look. Unlike existing sliding door systems, the base described in the present invention allows for all the lower tracks to be connected to each other even when three or more sliding doors are installed in parallel. The lower tracks of the “Smart Track” are connected in a manner that allows enough room for the doors supported by the tracks to slide in parallel with each other without touching, and such that no gap exists between the lower tracks. Further, as described above, a feature of the “Smart Track” is that it may be installed on top of the floor with ADA-complaint ramps on either side, or recessed into the flooring without the ramps. The “Smart Track” may also be installed with only one ramp on one side, when desired. The “smart track” base is easy and convenient to install, and is safe.

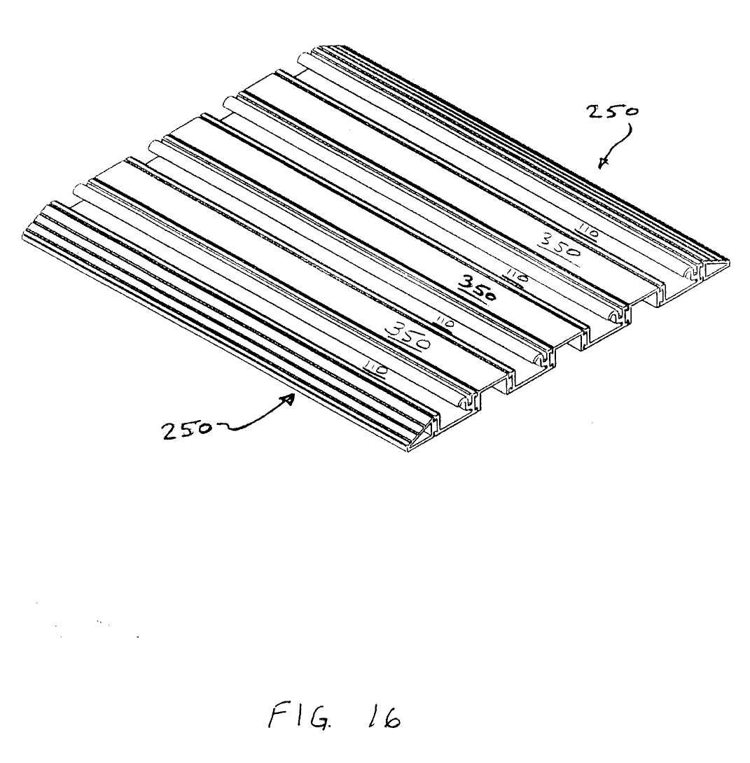

FIG. 16 shows another preferred embodiment, in which a base for a sliding door system that has four doors includes four lower tracks 110 and three connectors 350, with each of two “outer” lower tracks 110 coupled to a respective ramp 250 on one side and a respective connector 350 on the opposing side. Each connector 350 is then coupled to a respective “inner” lower track 110 on a side of each connector 350 that opposes the side coupled to each respective “outer” lower track. The remaining connector 350 is then connected to, and between, the two “inner” lower tracks 110.

The invention may include more than four lower tracks, with each “inner” lower track 110 having a connector 350 connected on both sides and each “outer” lower track having a connector 350 connected on one side and a ramp 250 connected on the opposing side. Again, an existing sliding door system would require the installation of multiple sets of lower tracks to implement the above. This would typically result in unsafe and unaesthetic gaps between the additional sets of lower tracks. The present invention solves these problems by defining a modular base that lacks noticeable gaps between the lower tracks, connectors and ramps. Further, the present invention is made even safer by, in some embodiments, defining ramps of a particular width and angle such that the ramps provide stability to the base and reduce the risk of one tripping over the base. In addition, the modular base of the present invention is convenient in that it allows users to add lower tracks and sliding doors with relative ease and may be installed on top of a floor or other surface.

It is noted that the “Smart Track” modular base may include ramps on both sides of the base, on only one side of the base, or the modular base may be recessed into the ground with no ramps.

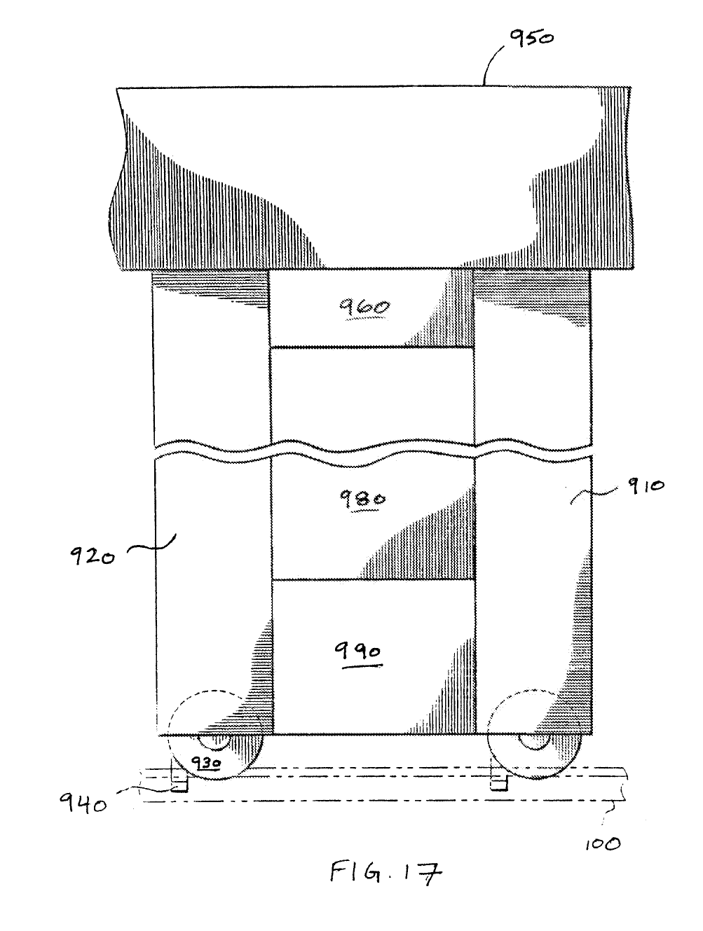

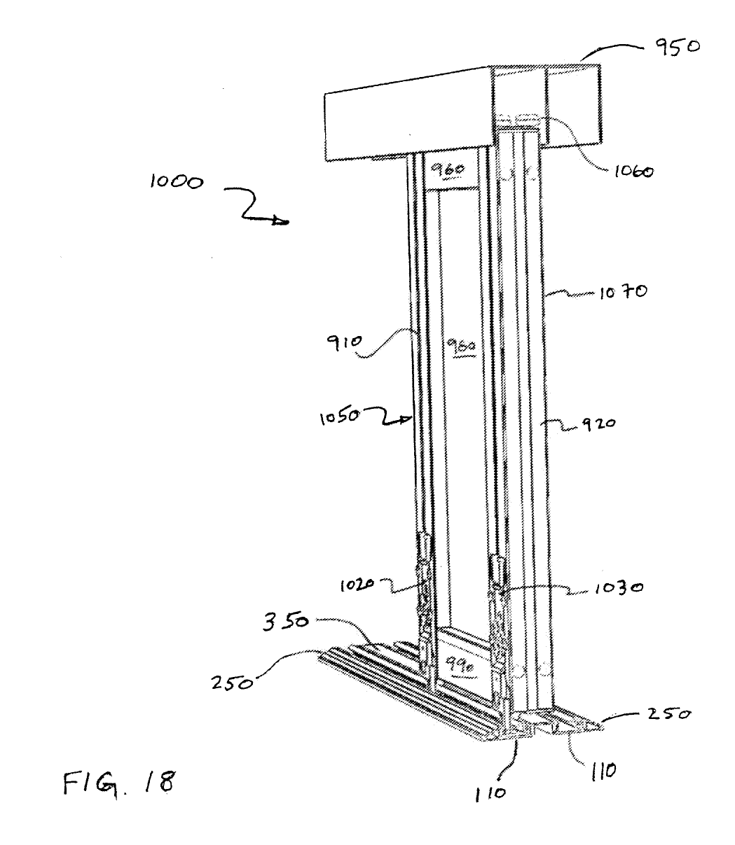

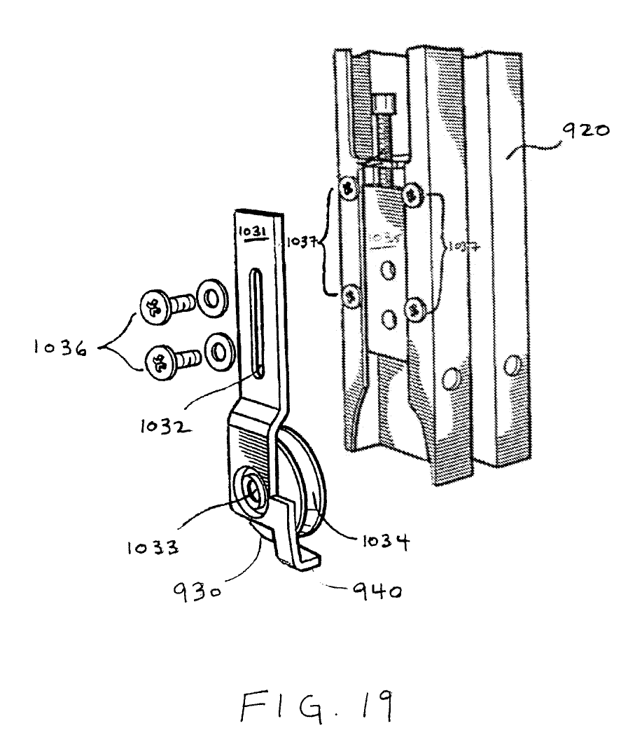

FIGS. 17-19 provide an example of a sliding door assembly that may connect to lower tracks 110 in accordance with the present invention. FIGS. 17-19 show a sliding door assembly 1000 that includes a door 1050, two lower tracks 110, two ramps 250, a connector 350, and an upper track 950. The door includes a panel 980 encased within a frame 1070 which comprises a horizontal top portion (or member) 960, a horizontal bottom portion 990, a first vertical side portion 910, and a second vertical side portion 920. As shown, opposing horizontal members 960 and 990 are vertically spaced apart from one another, and opposing vertical members 910 and 920 are horizontally spaced apart from one another. In embodiments of the invention, the members 910, 920, 960, 990 may be made of aluminum. In addition, in embodiments where the panel 980 is made of glass, the glass may be tempered, and have a thickness of at least 4.0 mm, and more preferably, a thickness of at least 5.0 mm.

In this embodiment of the invention, the sliding door assembly 1000 includes at least one upper roller assembly 1060 and one lower wheel assembly 1020. The upper roller assembly 1060 is coupled to an upper part of the frame 1070 that is proximate the horizontal top portion 960, and the lower wheel assembly 1020 is coupled to a lower part of the frame 1070 that is proximate the horizontal bottom portion 990. Preferably, for each door 1050, one upper roller assembly 1060 is disposed atop each of the vertical side portions 910, 920, and one lower wheel assembly 1020, 1030 is disposed at the bottom of each of the vertical side portions 910, 920.

In a preferred embodiment, the lower wheel assembly 1030 includes a vertical spine 1031 which, in turn, has a vertical slot 1032 through its central portion. The vertical spine 1031 also includes a transverse shaft 1033 that is coupled towards a bottom portion of the spine, and a latch member 940 extending transversely from the vertical spine's bottom, at a location below the shaft 1033. Rotatably coupled to the transverse shaft 1033 is a lower wheel 930 that has a channel, or groove, 1034 that runs along its periphery so as to define a concave contact surface for the lower wheel 930.

The spine 1031 connects to a mounting bracket 1035 by attachment means, such as, for example, screws or bolts 1036, through the vertical slot 1032. The mounting bracket, in turn, couples to the back side of the vertical side portion 920 using screws or similar attachment means 1037.

In preferred embodiments, each lower track 110 includes a convex longitudinal (rail) portion 160 that mates with the lower wheel's concave channel 1034. In addition, a concave channel 180 defined by the underside of the convex longitudinal portion 160 provides a surface for engaging the latch member 940. Thus, the latch member 940 slidably engages the channel 180 such that, as the lower wheel 930 rotates on the outer side of the convex longitudinal portion 160, the door 1050 remains latched to the lower track 110.

While the description above refers to particular embodiments of the present invention, it will be understood that modifications may be made without departing from the spirit thereof. The accompanying claims are therefore intended to cover such modifications as would fall within the true scope and spirit of the present invention.

What is claimed is:

1. A modular interior sliding door system comprising:
(a) an interior, non-hanging, sliding door having a panel that is encased within a frame, wherein said frame comprises opposing first and second vertical side portions, a first lower wheel assembly coupled to said first vertical side portion, and a second lower wheel assembly coupled to said second vertical side portion, wherein each of said first and second lower wheel assemblies comprises a lower wheel that is rotatably coupled to a transverse shaft and a transverse latch member disposed vertically below said lower wheel; and
(b) a modular base comprising:
(1) a first lower track having a first longitudinal side, a second longitudinal side, and a longitudinal portion that is configured to mate with a periphery of each of said lower wheels so as to allow each said lower wheel to matingly rotate on said longitudinal portion, said transverse latch member of each lower wheel assembly slidably engaging a channel defined by an underside of said longitudinal portion so as to slidably latch each said lower wheel assembly to said first lower track as each lower wheel rotates on said longitudinal portion;
(2) a first ramp member that mates with said first lower track; and
(3) a second ramp member.

2. The modular interior sliding door system of claim 1, wherein the first ramp member mates with the first longitudinal side of the first lower track and the second ramp member mates with the second longitudinal side of said first lower track.

3. The modular interior sliding door system of claim 1, wherein:
(a) said periphery of said lower wheel includes a channel defining a concave contact surface;
(b) said longitudinal portion of said first lower track is convex; and
(c) said longitudinal portion defines a concave channel on the underside thereof.

4. The modular interior sliding door system of claim 1, wherein said first lower wheel assembly is only coupled to said frame's first vertical side portion, and said second lower wheel assembly is only coupled to said frame's second vertical side portion.

5. The modular interior sliding door system of claim 1, wherein said transverse latch member is further disposed parallel to said transverse shaft.

6. The modular interior sliding door system of claim 1, wherein:
(a) said first ramp member is configured to mate with either the first or the second longitudinal side of said first lower track; and
(b) said second ramp member is configured to mate with either the first or the second longitudinal side of said first lower track.

7. The modular interior sliding door system of claim 1, wherein each of said first and second lower wheel assemblies comprises:
(1) a vertical spine having a vertical slot through a central portion thereof and said transverse shaft coupled to a bottom portion thereof, said transverse shaft being disposed perpendicular to the plane of the panel; and
(2) a mounting bracket that is configured to be coupled to a respective one of said first and second vertical side portions via attachment means selected from the group consisting of screws, bolts, and combinations thereof, said mounting bracket being detachably coupled to the vertical spine through said vertical slot so as to allow vertical adjustment of the spine with respect to the bracket.

8. The modular interior sliding door system of claim 7, wherein said mounting bracket is configured to be coupled only to a backside of a respective one of said first and second vertical side portions.

9. The modular interior sliding door system of claim 1, wherein said modular base further comprises:
(a) a second lower track having a free side and an opposing side that is configured to mate with said second ramp; and
(b) a connector having a first longitudinal side that is configured to mate with the second longitudinal side of said first lower track and a second longitudinal side that is configured to mate with the free side of the second lower track.

10. The modular interior sliding door system of claim 1, wherein said frame further comprises a horizontal top portion and a horizontal bottom portion.

11. The modular interior sliding door system of claim 10, wherein said door further includes first and second upper roller assemblies respectively disposed proximate opposing ends of said horizontal top portion and an upper track configured to receive said upper roller assemblies so as to allow the door to slide horizontally between said lower and upper tracks.

12. The modular interior sliding door system of claim 11, further including at least a second interior, non-hanging, sliding door, wherein said second sliding door comprises a second pair of lower wheel assemblies and a second pair of upper roller assemblies, and each of the upper roller assemblies includes two rollers.

13. The modular interior sliding door system of claim 12, wherein said modular base further comprises a second lower track having a free side and an opposing side that is configured to mate with said second ramp and a connector having a first longitudinal side that is configured to mate with the second longitudinal side of said first lower track and a second longitudinal side that is configured to mate with the free side of the second lower track, wherein the upper track includes a first channel to receive the rollers of the first door's upper roller assemblies and a second channel parallel to said first channel to receive the rollers of the second pair of upper roller assemblies, the second lower track includes a longitudinal portion parallel to the longitudinal portion of said first lower track, and each of said second pair of lower wheel assemblies has a lower wheel that matingly rolls on the longitudinal portion of said second lower track.

14. The modular interior sliding door system of claim 13, wherein each of said second pair of lower wheel assemblies further includes a latch member that engages the underside of the longitudinal portion of said second lower track so as to slidably latch the second sliding door to the second lower track.

15. The modular interior sliding door system of claim 14, wherein each of the longitudinal portions of said first lower track and said second lower track is convex.

16. The modular interior sliding door system of claim 1, wherein said modular base further comprises:
(a) a second lower track having first and second longitudinal sides;
(b) a first connector having a first longitudinal side that is configured to mate with the second longitudinal side of said first lower track and a second longitudinal side that is configured to mate with the first longitudinal side of said second lower track;
(c) a third lower track having a free side and a side configured to mate with said second ramp; and
(d) a second connector having a first longitudinal side that is configured to mate with the second longitudinal side of said second lower track and a second longitudinal side that is configured to mate with the free side of said third lower track.

17. The modular interior sliding door system of claim 1, wherein said modular base further comprises:
(a) a second lower track having a first and a second longitudinal side;
(b) a first connector having a first longitudinal side that is configured to mate with the second longitudinal side of said first lower track and a second longitudinal side that is configured to mate with the first longitudinal side of said second lower track;
(c) a third lower track having first and second longitudinal sides;
(d) a second connector having a first longitudinal side that is configured to mate with the second longitudinal side of said second lower track and a second longitudinal side that is configured to mate with the first longitudinal side of said third lower track;
(e) a fourth lower track having a free side and a side configured to mate with said second ramp; and
(f) a third connector having a first longitudinal side that is configured to mate with the second longitudinal side of said third lower track and a second longitudinal side that is configured to mate with the free side of said fourth lower track.

18. A modular base for use with an interior, non-hanging, sliding door having a first lower wheel and a second lower wheel, the modular base comprising:
(a) a first lower track having a first longitudinal side, a second longitudinal side, and a longitudinal portion that is configured to mate with a periphery of each of said lower wheels so as to allow each said lower wheel to matingly rotate on said longitudinal portion;
(b) a first ramp member that mates with said first lower track;
(c) a second ramp member;
(d) a second lower track having a free side and an opposing side that is configured to mate with said second ramp; and
(e) a connector having a first longitudinal side that is configured to mate with the second longitudinal side of said first lower track and a second longitudinal side that is configured to mate with the free side of the second lower track.

19. The modular base of claim 18, wherein the second lower track includes a longitudinal portion parallel to the longitudinal portion of said first lower track, said longitudinal portion configured to mate with a periphery of each of said lower wheels so as to allow each said lower wheel to matingly rotate on said longitudinal portion;

20. The modular base of claim 19, wherein each of the longitudinal portions of said first lower track and said second lower track is convex.
